(19) United States
(12) Patent Application Publication
(10) Pub. No.: US 2025/0362280 A1
(43) Pub. Date: Nov. 27, 2025

(54) PREPARATIVE LIQUID CHROMATOGRAPH AND METHOD FOR CONTROLLING THE SAME

(71) Applicant: SHIMADZU CORPORATION, Kyoto (JP)

(72) Inventor: Iori OTOMO, Kyoto (JP)

(73) Assignee: SHIMADZU CORPORATION, Kyoto (JP)

(21) Appl. No.: 19/185,333

(22) Filed: Apr. 22, 2025

(30) Foreign Application Priority Data
May 27, 2024 (JP) 2024-085838

(51) Int. Cl. G01N 30/86; B01D 15/10; G01N 30/02

(52) U.S. Cl. CPC G01N 30/8631; B01D 15/102; G01N 2030/027

(57) ABSTRACT

For the preparative separation of sample components accompanying a sample injection for each of plural sample injections, a preparative liquid chromatograph is controlled as follows: In the preparative separation of sample components accompanying the first sample injection, the separative collection of a sample component corresponding to a peak is performed by a separative collector for each peak emerging on a chromatogram, and the beginning time of each peak on the chromatogram is stored. In the preparative separation of sample components accompanying the second or subsequent sample injection, every peak emerging on the chromatogram is designated as a target peak, whether or not the target peak originates from the same component as one of the peaks is determined based on the beginning time of the target peak and those of the peaks, and the separative collector is operated to perform a predetermined separative collection operation based on the determination result.

### TECHNICAL FIELD

The present invention relates to a preparative liquid chromatograph and a method for controlling a preparative liquid chromatograph.

### BACKGROUND ART

As a device for separating a plurality of components in a sample and separately collecting the components, a preparative liquid chromatograph has been known which is configured to temporally separate the components by a column in a high-performance liquid chromatograph (or similar device) and subsequently collect each component by a fraction collector.

A preparative liquid chromatograph includes: a liquid chromatograph (LC) unit having a liquid-supply pump, column and detector; a fraction collector located in the subsequent stage from the LC unit; and a control unit configured to control these devices. Sample components temporally separated from each other by the column and exiting from the same column are sequentially detected by the detector, such as an ultraviolet-visible spectrophotometer, and introduced into the fraction collector in the subsequent stage. In the fraction collector, the internal passage is switched according to an instruction from the control unit so that the target component is collected into a collection container, such as a vial container.

Most preparative liquid chromatographs have a function called the “automatic preparative separation” for automatically collecting components exiting from the column. In the automatic preparative separation, the control unit detects a peak emerging on a chromatogram created based on the output signals from the detector and controls the fraction collector so that the fraction corresponding to the peak in the eluate from the column is collected in a separate collection container. The condition for detecting a peak (e.g., the threshold of the signal level of the chromatogram, or that of the gradient of the curve of the chromatogram) is previously set by the user.

### CITATION LIST

### Patent Literature

Patent Literature 1: JP H01-221663A

### SUMMARY OF INVENTION

### Technical Problem

In the previously described type of preparative liquid chromatograph, a plurality of sample injections with the same content and a plurality of automatic preparative separations accompanying the sample injections may be performed. It should be noted that “a plurality of sample injections with the same content” means either the sequential injection of a plurality of samples considered to be identical in composition into the LC unit or the injection of a plurality of fractions of the same sample into the LC unit. In these cases, a peak which did not emerge on a chromatogram obtained in connection with the first sample injection may possibly emerge on a chromatogram obtained in connection with the second or subsequent sample injection. Possible causes of this situation are: a residual component which had been present in the passage since the last use of the preparative liquid chromatograph and was eluted due to the second or subsequent sample injection; a procedural variation in the process of preparing the plurality of samples; or the mixture of a residual component which was present in a sample container. Therefore, a peak which only emerges from the second or subsequent sample injection originates from a foreign substance which does not always need to be collected in the preparative separation process. However, in the conventional preparative liquid chromatograph which performs automatic preparative separation, a component corresponding to such a peak is also collected by the fraction collector, which causes problems such as an increase in the number of collection containers used or the complication of the handling of the collected fractions.

In the plurality of automatic preparative separations accompanying the plurality of sample injections with the same content, there may be cases in which the same kind of component contained in each of the individually injected samples should be collected in one collection container. In such a case, the operation of the fraction collector should be controlled so that, for each chromatogram obtained in connection with one sample injection, the component corresponding to the first peak on the chromatogram is collected in the first collection container within the fraction collector, the component corresponding to the second peak is collected in the second collection container, and the component corresponding to the N-th peak is collected in the N-th collection container. However, when this control is performed, different components will be collected in one collection container if the number of peaks emerging on the chromatogram changes from one injection to another. As a specific example, consider the case where peaks 1 and 2 shown in FIG. 4 emerged in connection with the first sample injection, peaks 3, 4 and 5 in the same figure emerged in connection with the second sample injection, and peaks 6, 7, 8 and 9 emerged in connection with the third sample injection. In this case, the components which correspond to the first peaks 1, 3 and 6 on the respective chromatograms will be collected in the first collection container within the fraction collector, and the components which correspond to the second peaks 2, 4 and 7 on the respective chromatograms will be collected in the second collection container, so that different components (i.e., components with different retention times) will be mixed in each collection container.

A conventional preparative liquid chromatograph which performs automatic preparative separation has a function which allows the user to specify peaks as the targets of separative collection on a chromatogram previously acquired by injecting a test sample into the LC unit, and to store the signal levels, gradients and retention times at the beginning and ending points of each peak. When the preparative separation of an actual sample is performed, the separative collection of a component corresponding to a peak located on the chromatogram of the sample is performed when the signal levels of the peak match with the stored levels and its gradients and retention times fall within their respective predetermined ranges before and after their respective stored values (for example, see Patent Literature 1). When this type of preparative liquid chromatograph is used, the previously described problems will not occur since the separative collection is only performed for a component corresponding to a peak whose retention time is close to a peak which emerged from the injection of the test sample (preliminary injection). However, this technique requires the preliminary injection and inevitably consumes the time and sample for the preliminary injection. Particularly, this technique cannot be applied to a valuable sample from which an appropriate amount of sample for the preliminary injection cannot be easily obtained.

The present invention has been developed in view of the previously described problems. Its objective is to make it possible to reduce the number of collection containers used as well as facilitate the handling of collected fractions without performing a preliminary injection, or to assuredly collect the same component into the same container without performing a preliminary injection, when automatic preparative separations accompanying a plurality of sample injections with the same content are performed by a preparative liquid chromatograph.

### Solution to Problem

A method for controlling a preparative liquid chromatograph according to the present invention developed for solving the previously described problem is a method for controlling a preparative liquid chromatograph having a separation column configured to separate a plurality of sample components contained in a sample injected into a passage, a detector located downstream from the separation column, a chromatogram creator configured to create a chromatogram based on a detection result by the detector, and a separative collector configured to perform a separative collection, from an eluate from the separation column, of a sample component corresponding to a peak on the chromatogram, where the method includes performing the following operations when the preparative separation of sample components accompanying a sample injection is performed for each of a plurality of sample injections into the passage:
when the preparative separation of sample components accompanying the first sample injection among the plurality of sample injections is performed, the separative collection of a sample component corresponding to a peak is performed by the separative collector for each of the peaks emerging on a first chromatogram which is a chromatogram created by the chromatogram creator in connection with the first sample injection, and the beginning time of each of the aforementioned peaks on the first chromatogram is stored; and
when the preparative separation of sample components accompanying the second or subsequent sample injection among the plurality of sample injections is performed, every peak emerging on a target chromatogram which is a chromatogram created by the chromatogram creator in connection with the second or subsequent sample injection is designated as a determination target peak, a determination of whether or not the determination target peak originates from the same component as one of the aforementioned peaks is made based on the beginning time of the determination target peak on the target chromatogram and the beginning time of each of the aforementioned peaks on the first chromatogram, and the separative collector is operated to perform a predetermined separative collection operation based on the result of the determination.

A preparative liquid chromatograph according to the present invention developed for solving the previously described problem is a preparative liquid chromatograph having a separation column configured to separate a plurality of sample components contained in a sample injected into a passage, a detector located downstream from the separation column, a chromatogram creator configured to create a chromatogram based on a detection result by the detector, a separative collector configured to perform a separative collection, from an eluate from the separation column, of a sample component corresponding to a peak on the chromatogram, and a separative collection controller configured to control the separative collector, where the separative collection controller is configured to perform the following operations when the preparative separation of sample components accompanying a sample injection is performed for each of a plurality of sample injections into the passage:
when the preparative separation of sample components accompanying the first sample injection among the plurality of sample injections is performed, the separative collection controller controls the separative collector to perform the separative collection of a sample component corresponding to a peak for each of the peaks emerging on a first chromatogram which is a chromatogram created by the chromatogram creator in connection with the first sample injection, and stores the beginning time of each of the aforementioned peaks on the first chromatogram; and
when the preparative separation of sample components accompanying the second or subsequent sample injection among the plurality of sample injections is performed, the separative collection controller designates, as a determination target peak, every peak emerging on a target chromatogram which is a chromatogram created by the chromatogram creator in connection with the second or subsequent sample injection, makes a determination of whether or not the determination target peak originates from the same component as one of the aforementioned peaks based on the beginning time of the determination target peak on the target chromatogram and the beginning time of each of the aforementioned peaks on the first chromatogram, and controls the separative collector to perform a predetermined separative collection operation based on the result of the determination.

### Advantageous Effects of Invention

By the method for controlling a preparative liquid chromatograph according to the present invention or the preparative liquid chromatograph according to the present invention, it is possible to reduce the number of collection containers used as well as facilitate the handling of collected fractions without performing a preliminary injection, or to assuredly collect the same component into the same container without performing a preliminary injection, when automatic preparative separations accompanying a plurality of sample injections with the same content are performed.

### BRIEF DESCRIPTION OF DRAWINGS

FIG. 1 is a diagram showing a schematic configuration of a preparative liquid chromatograph according to the first embodiment of the present invention.

FIG. 2 is a block diagram showing the configuration of the main components of the control unit in the same embodiment.

FIG. 3 is a flowchart showing an operation of the preparative liquid chromatograph according to the same embodiment.

FIG. 4 is a diagram showing one example of the chromatogram created for each of a plurality of sample injections with the same content.

FIG. 5 is a flowchart showing another example of the operation of the preparative liquid chromatograph according to the present invention.

FIG. 6 is a diagram showing a schematic configuration of a preparative liquid chromatograph according to the second embodiment of the present invention.

### DESCRIPTION OF EMBODIMENTS

### First Embodiment

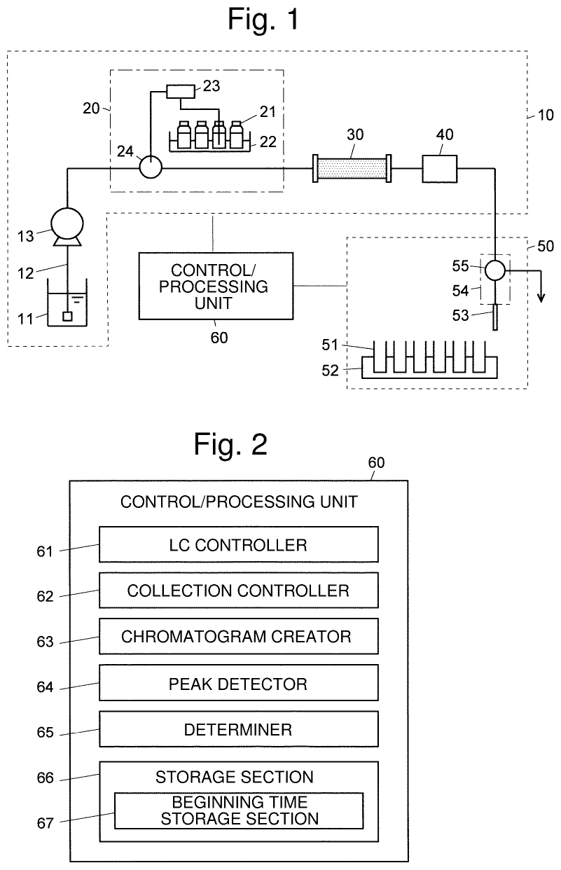

Modes for carrying out the present invention are hereinafter described with reference to the drawings. FIG. 1 is a schematic configuration diagram of a preparative liquid chromatograph according to one embodiment of the present invention. This preparative liquid chromatograph includes an LC unit 10, fraction collector 50, and control/processing unit 60. In the present embodiment, the fraction collector 50 corresponds to the separative collector in the present invention.

The LC unit 10 includes a mobile phase container 11 and a mobile phase passage 12, as well as a mobile phase supply pump 13, automatic sample injection device 20, separation column 30 and detector 40 which are provided on the mobile phase passage 12. The detector 40 may be any type of detector commonly used in liquid chromatographs; for example, an absorbance detector or differential refractive index detector can be used.

The automatic sample injection device 20 includes: a sample-container holder 22 configured to hold a plurality of sample containers 21 each of which contains a liquid sample; a suction unit 23 configured to suction a predetermined amount of sample from one selected sample container 21; and an injector 24 configured to inject the sample suctioned by the suction unit 23 into the mobile phase passage 12.

The fraction collector 50 includes: a container receiver 52 configured to receive a plurality of collection containers 51 (which correspond to the separative-collection destinations in the present invention); a nozzle head 54 having a dispensing nozzle 53 at its lower end; a dispensing valve 55 built in the nozzle head 54 and configured to switch the destination of the liquid coming from the L C unit 10 to either the drain or the dispensing nozzle 53; and a driving unit (not shown) configured to drive the nozzle head 54 in the back-and-forth, up-and-down and right-and-left directions.

The control/processing unit 60 consists of a general-purpose computer (such as a personal computer) or a dedicated computer, or a combination of these types of computers. This unit is configured to control the previously described sections as well as perform predetermined data processing based on the output signals from the detector 40 of the LC unit 10.

The configuration of the control/processing unit 60 is shown in FIG. 2. The control/processing unit 60 includes: an LC controller 61 configured to control the LC unit 10; a collection controller 62 (which corresponds to the separative collection controller in the present invention) configured to control the fraction collector 50; a chromatogram creator 63 configured to create a chromatogram in substantially real time based on the output signals from the detector 40; a peak detector 64 configured to detect the beginning and ending points of a peak emerging on the chromatogram with the passage of time; and a determiner 65 configured to make a predetermined determination (which will be described later). All of these components are functional blocks realized in the form of software components by the CPU in the computer acting as the control/processing unit 60, by loading a dedicated program installed on a hard disk drive or similar large-volume storage device provided in the computer, into the memory of the same computer and executing the same program. The control/processing unit 60 further includes a storage section 66, in which a beginning time storage section 67 is provided (details of which will be described later). The functions of the storage section 66 are realized, for example, by a large-volume storage device provided in the computer. Additionally, though not shown, an input unit consisting of a keyboard, mouse or other devices, as well as a display device consisting of a liquid display or similar device, are connected to the computer acting as the control/processing unit 60.

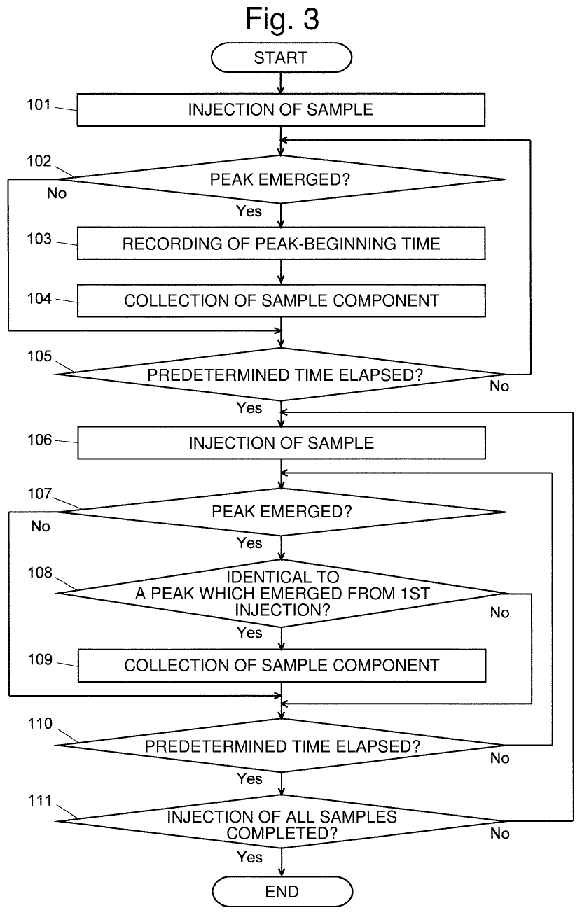

Next, an operation of the preparative liquid chromatograph according to the present embodiment is described with reference to the flowchart of FIG. 3.

Before an automatic preparative separation using the preparative liquid chromatograph according to the present embodiment is performed, a plurality of sample containers 21 (e.g., all of which contain samples of the same composition) should be previously set in the automatic sample injection device 20, and a plurality of collection containers 51 for containing various kinds of components in the samples (“sample components”) should also be set in the fraction collector 50. Furthermore, by operating the input unit, the user should enter the injection condition which specifies in what order and in what quantity the samples should be suctioned from the sample containers 21 in the automatic sample injection device 20, as well as the condition for the detection of the peak-beginning and peak-ending points in the peak detector 64 (e.g., the threshold of the signal level of the chromatogram, or that of the gradient of the curve of the chromatogram). These conditions are stored in the storage section 66.

The user issues a command to initiate the automatic preparative separation through the input unit. Then, under the control of the LC controller 61, a preset amount of sample is suctioned from a previously specified sample container 21 in the automatic sample injection device 20 and injected from the injector 24 into the mobile phase passage 12 (Step 101). The sample injection in Step 101 is hereinafter called the “first sample injection”.

A mobile phase suctioned from the mobile phase container 11 by the mobile phase supply pump 13 is flowing through the mobile phase passage 12. The sample injected into the mobile phase passage 12 by the automatic sample injection device 20 is carried by this flow of the mobile phase and introduced into the inlet end of the separation column 30. While the sample is passing through the separation column 30, the sample components are separated from each other and exit sequentially from the outlet end of the separation column 30. The liquid exiting from the outlet end of the separation column 30 (this liquid is hereinafter called the “eluate”) passes through the detector 40 before being discharged into the drain via the dispensing valve 55 in the fraction collector 50. The output signals of the detector 40 obtained in this process are converted into digital values by an analogue-to-digital converter (not shown) and sent to the control/processing unit 60.

In the control/processing unit 60, the chromatogram creator 63 begins creating a chromatogram which shows the temporal change of the detection signal from the detector 40 based on the digital values. The peak detector 64 determines, at predetermined intervals of time, whether or not a peak has emerged on the chromatogram (Step 102). Whether or not a peak has emerged is determined based on whether the beginning point of a peak has or has not been detected. The method for detecting the beginning point of a peak is not specifically limited; any of the various conventionally known techniques may be used, such as a technique based on the signal level of the chromatogram, or a technique based on the gradient of the curve of the chromatogram, or a technique based on both of these criteria.

When it has been concluded in Step 102 that a peak has emerged, the control/processing unit 60 stores, in the beginning time storage section 67, the point in time of the emergence (the elapsed time since the first sample injection) as the peak-beginning time of that peak (Step 103). Furthermore, the control/processing unit 60 operates the fraction collector 50 so that the fraction corresponding to the peak in the eluate from the separation column 30 is collected into a predetermined collection container 51 in the fraction collector 50 (Step 104). Specifically, under the control of the collection controller 62, the fraction collector 50 transfers the nozzle head 54 to a position above the predetermined collection container 51 and switches the dispensing valve 55 from the drain to the dispensing nozzle 53 at the timing when the fraction of the eluate corresponding to the beginning point of the peak arrives at the dispensing valve 55, whereby the eluate is ejected from the dispensing nozzle 53 into the predetermined collection container 51. After the ending point of the peak is detected by the peak detector 64, and at the timing when the fraction of the eluate corresponding to the ending point of the peak arrives at the dispensing valve 55, the dispensing valve 55 is switched from the dispensing nozzle 53 into the drain so that the eluate will be discharged from the drain. The method for detecting the ending point of a peak is also not specifically limited; any of the various conventionally known techniques may be used, such as a technique based on the signal level of the chromatogram, or a technique based on the gradient of the curve of the chromatogram, or a technique based on both of these criteria.

The previously described operation of switching the dispensing valve 55 is performed at the timing determined considering the period of time required for the eluate to flow from the detector 40 to the dispensing valve 55.

Subsequently, whether or not a predetermined period of time has passed since the first sample injection is determined (Step 105). When it has been concluded that the predetermined period of time has not yet passed, the operation returns to Step 102. After that, when it has been concluded that a new peak has emerged on the chromatogram (i.e., when the result of Step 102 is “Y es”), the recording of the peak-beginning time for the new peak (Step 103) and the collection of the sample component corresponding to the new peak (Step 104) are performed. Regarding Step 104, it should be noted that the sample components which correspond to the respective peaks on the chromatogram are individually collected in separate collection containers 51.

When it has been concluded in Step 105 that the predetermined period of time has passed since the first sample injection, the automatic preparative separation accompanying the first sample injection is discontinued.

Subsequently, under the control of the LC controller 61, a preset amount of sample is suctioned from a previously specified sample container 21 in the automatic sample injection device 20 and injected into the mobile phase passage 12 (Step 106). This operation is hereinafter called the “second sample injection”.

After the second sample injection has been performed, the chromatogram creator 63 begins to create a chromatogram in connection with the second sample injection, and the peak detector 64 determines, at predetermined intervals of time, whether or not a peak has emerged on the chromatogram (Step 107).

When it has been concluded in Step 107 that a peak has emerged (i.e., when the beginning point of a peak has been detected by the peak detector 64), the determiner 65 makes a determination of whether or not that peak is identical to any one of the peaks which emerged from the first sample injection (whether or not it originates from the same component) based on the beginning time of that peak, i.e. the elapsed time from the immediately preceding sample injection (in the present case, the second sample injection) to the detection of the beginning point of the same peak (Step 108). Specifically, the peak-beginning times of the peaks detected in connection with the first sample injection (these peaks are hereinafter called the “compared peaks”) are read from the beginning time storage section 67. If the difference between any one of the read peak-beginning times and the beginning time of the peak detected in Step 107 (this peak is hereinafter called the “determination target peak”) is within a predetermined allowable range of error, it is concluded that the determination target peak is identical to one of the peaks which emerged from the first sample injection. Conversely, if none of the beginning times of the compared peaks fall within the allowable range of error from the beginning time of the determination target peak, it is concluded that the determination target peak is not identical to any peak which emerged from the first sample injection. The value of the allowable amount of error is previously set and stored in the storage section 66 by the user or the maker of the preparative liquid chromatograph according to the present embodiment. It should be noted that, in the preparative liquid chromatograph according to the present embodiment, as just described, the determination of whether or not the determination target peak is identical to any of the peaks which emerged from the first sample injection is based on the beginning times of the peaks. Therefore, for example, the period of time required for the determination can be shorter than in the case of making the determination based on the waveform processing of the peaks focused on the similarity in peak shape.

When it has been concluded in Step 108 that the determination target peak is identical to a peak which emerged from the first sample injection, the fraction collector 50 collects, into a predetermined collection container 51, the fraction corresponding to the determination target peak in the eluate from the separation column 30 (Step 109). This collection container 51 should be an empty collection container 51 which was not used in the automatic preparative separation accompanying the first sample injection. The specific collecting method is similar to the previously described Step 104, and therefore, its description will be omitted.

Conversely, when it has been concluded in Step 108 that the determination target peak is not identical to any peak which emerged from the first sample injection, the fraction of the eluate corresponding to the determination target peak is discharged into the drain via the dispensing valve 55 of the fraction collector 50 without being collected.

After that, whether or not a predetermined period of time has passed since the second sample injection is determined (Step 110). When it has been concluded that the predetermined period of time has not yet passed, the operation returns to Step 107 to repeat Steps 107 through 110.

When it has been concluded in Step 110 that the predetermined period of time has passed since the second sample injection, the automatic preparative separation accompanying the second sample injection is discontinued, and whether or not the injection of all samples designated beforehand has been completed is determined (Step 111). In this step, if it has been concluded that the injection of all samples has not yet been completed, the operation returns to Step 106 to perform the third sample injection.

After that, Steps 106 through 111 are repeatedly performed until it is determined in Step 111 that the injection of all samples has been completed. The entire series of processing is discontinued when it has been concluded in Step 111 that the injection of all samples has been completed.

Thus, the preparative liquid chromatograph according to the present embodiment can prevent the situation in which a component that is only detected in the second or subsequent sample injection is collected in the automatic preparative separations accompanying a plurality of sample injections. Therefore, in the case of performing a plurality of automatic preparative separations accompanying a plurality of sample injections with the same content, the collection of foreign substances can be prevented, so that the number of collection containers 51 used can be reduced and the complication of the handling of the collected fractions can be avoided, even without performing a preliminary injection.

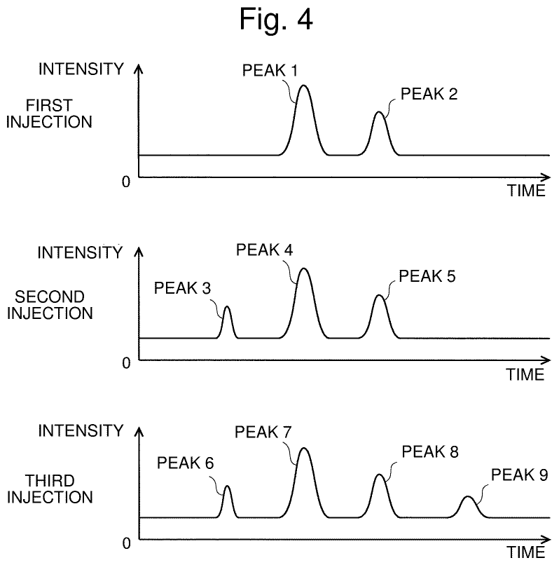

In the previously described embodiment, the sample components collected in the automatic preparative separations accompanying the first, second and subsequent sample injections are individually collected into separate collection containers 51. For example, consider the case where peaks 1 and 2 as shown in FIG. 4 emerged from the first sample injection, peaks 3-5 as shown in the same figure emerged from the second sample injection, and peaks 6-9 as shown in the same figure emerged from the third sample injection. In this case, the fractions of the eluate corresponding to the peaks 1, 2, 4, 5, 7 and 8 will be sequentially collected into separate collection containers 51 (e.g., the first through sixth collection containers 51 in the fraction collector 50) in order of the detection of the peaks, while the fractions corresponding to the peaks 3, 6 and 9 which only emerged from the second and subsequent injections will be disposed of without being collected.

However, the present invention is not limited to this type of operation. For example, in the automatic preparative separation accompanying each of the second and subsequent sample injections, if a peak detected in connection with the second or subsequent sample injection (the determination target peak) has been concluded to be identical to a peak which emerged from the first injection (the compared peak), the sample component corresponding to that peak may be collected in the same collection container 51 as used for collecting the sample component corresponding to the compared peak which has been concluded to be identical. In this case, the sample components corresponding to the peaks 1, 4 and 7 in the example shown in FIG. 4 will be collected together in one collection container 51 (e.g., the first collection container 51 in the fraction collector 50), and the sample components corresponding to the peaks 2, 5 and 8 will be collected together in another collection container 51 (e.g., the second collection container 51 in the fraction collector 50), while the components corresponding to the peaks 3, 6 and 9 which did not emerge from the first sample injection will be disposed of without being collected. According to this method, the number of collection containers 51 used can be reduced as compared to the case where all of the sample components corresponding to the peaks 1, 4 and 7 as well as those corresponding to the peaks 2, 5 and 8 are individually collected in separate collection containers 51, and yet the situation in which different kinds of sample components are collected in one collection container 51 can be prevented.

As another possibility, sample components corresponding to the peaks which have emerged from the second and subsequent sample injections but did not emerge from the first sample injection may also be collected in collection containers 51. In that case, the sample components corresponding to the peaks which only emerge from the second and subsequent sample injections (in the example of FIG. 4, the peaks 3, 6 and 9) may be individually collected in separate collection containers 51, or two or more sample components corresponding to the peaks which commonly emerge from two or more of the second and subsequent sample injections (in the example of FIG. 4, the peaks 3 and 6) may be collected together in one collection container 51 (e.g., the third collection container in the fraction collector 50).

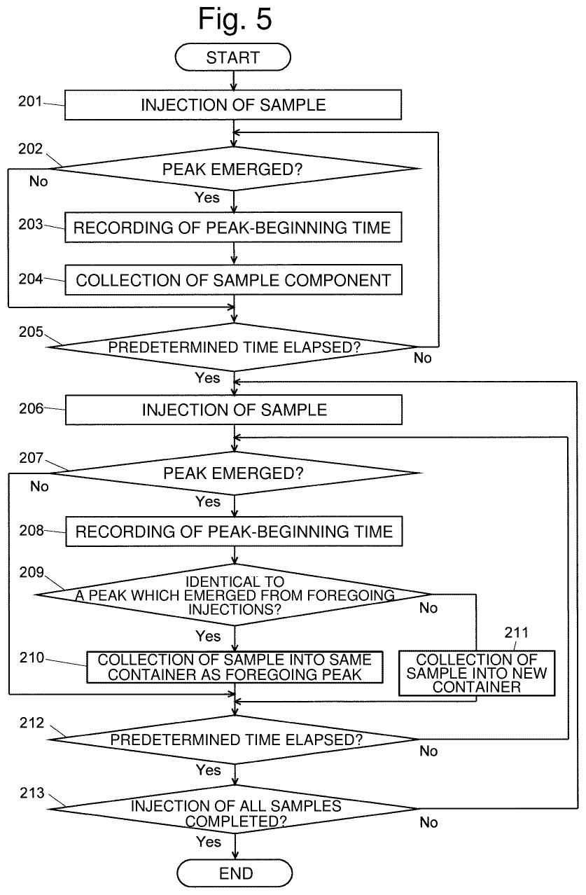

With reference to the flowchart of FIG. 5, an example of the preparative separation operation is hereinafter described in connection with the previously described case where the components corresponding to the peaks which commonly emerge from two or more of the second and subsequent sample injections among the peaks which only emerge from the second and subsequent sample injections are collected together in one collection container 51. It should be noted that Steps 201-207 in the flowchart of FIG. 5 are similar to Steps 101-107 in the flowchart of FIG. 3, and therefore, their description will be omitted.

In the flowchart of FIG. 5, when a peak-beginning point has been detected on the chromatogram created in connection with the second or subsequent sample injection (Step 206), i.e., when the result of Step 207 is “Y es”, the point in time of the detection (the elapsed time since the immediately preceding sample injection) is stored in the beginning time storage section 67 as the peak-beginning time of that peak (Step 208).

Then, the determiner 65 makes a determination of whether or not the peak detected in Step 207 (determination target peak) is identical to one of the peaks (compared peaks) detected in connection with the foregoing sample injections (the first to (N−1)-th sample injections, provided that the latest sample injection is the N-th injection, where N is equal to or greater than two) (Step 209). Specifically, if the difference between the beginning time of any one of the compared peaks stored in the beginning time storage section 67 and that of the determination target peak is within a predetermined allowable range of error, it is concluded that the determination target peak is identical to one of the peaks which emerged from the foregoing sample injections. Conversely, if none of the beginning times of the compared peaks fall within the allowable range of error from the beginning time of the determination target peak, it is concluded that the determination target peak is not identical to any peak which emerged from the foregoing sample injections.

When it has been concluded in Step 209 that the determination target peak is identical to one of the peaks which emerged from the foregoing sample injections, the fraction collector 50 collects the sample component corresponding to the determination target peak into the same collection container 51 as used for collecting the sample component corresponding to the compared peak which has been concluded to be identical to the determination target peak (Step 210). The method for collecting the sample component is similar to the previously described Step 104, and therefore, its description will be omitted.

Conversely, when it has been concluded in Step 209 that the determination target peak is identical to none of the peaks which emerged from the foregoing sample injections, the fraction collector 50 collects the sample component corresponding to the determination target peak into a new collection container 51 (a sample container 51 which has not been used for the automatic preparative separations accompanying the first through (N−1)-th sample injections, provided that the latest sample injection is the N-th injection, where N is equal to or greater than two) (Step 211).

Subsequently, whether or not a predetermined period of time has passed since the immediately preceding sample injection is determined (Step 212). When it has been concluded that the predetermined period of time has not yet passed, the operation returns to Step 207 to repeat the processing of Steps 207 through 212. After that, when it has been concluded in Step 212 that the predetermined period of time has passed since the immediately preceding sample injection, the operation proceeds to Step 213 to determine whether or not the injection of all samples designated beforehand has been completed. When it has been concluded that the injection of all samples has not yet been completed, the operation returns to Step 206 to repeat Steps 206 through 213. The entire series of processing is discontinued when it has been concluded in Step 213 that the injection of all samples has been completed.

For example, if the previously described operations are performed in the case shown in FIG. 4, the peaks 1, 4 and 7 will be collected in one collection container 51 (e.g., the first collection container 51 in the fraction collector 50), the peaks 2, 5 and 8 will be collected in another collection container 51 (e.g., the second collection container 51 in the fraction collector 50), the peaks 3 and 6 will be collected in still another collection container 51 (e.g., the third collection container 51 in the fraction collector 50), and the peak 9 will be collected in yet another collection container 51 (e.g., the fourth collection container 51 in the fraction collector 50).

It is preferable that a single preparative liquid chromatograph be configured to allow the user to previously select whether the components corresponding to the peaks which have been concluded to be identical should be collected together in one collection container 51 or be individually collected in separate collection containers 51. In the case where the components corresponding to the peaks which have been concluded to be identical should be collected together in one collection container 51, it is preferable to allow the user to previously select whether or not the peaks which only emerge from the second and subsequent sample injections should be collected. Furthermore, in the case where the peaks which only emerge from the second and subsequent sample injections should be collected, it is preferable to additionally allow the user to previously select whether the components corresponding to the peaks which commonly emerge from two or more of the second and subsequent sample injections among the peaks which only emerge from the second and subsequent sample injections should be collected together in one collection container 51 or be individually collected in separate collection containers 51.

The previously described example was a case in which the present invention was applied in a preparative liquid chromatograph configured to directly collect fractions of the eluate from the separation column 30 by means of the fraction collector 50. The present invention is not limited to this type of configuration; it may also be applied in a preparative liquid chromatograph in which various sample components contained in the eluate are temporarily trapped in trap columns before being collected. This type of configuration is hereinafter described.

### Second Embodiment

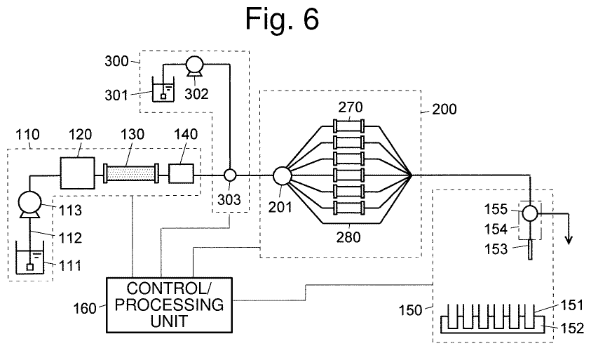

FIG. 6 shows the configuration of the main components of a preparative liquid chromatograph according to the second embodiment of the present invention. As shown in the figure, the preparative liquid chromatograph according to the present embodiment includes a component capture unit 200 including a plurality of trap columns 270 and a solvent supply unit 300 configured to supply an eluting solvent to each trap column 270, in addition to the LC unit 110, fraction collector 150 and control/processing unit 160 which are similar to those of the previous embodiment. In the present embodiment, the component capture unit 200 corresponds to the separative collector in the present invention, and the trap columns 270 correspond to the separative-collection destinations in the present invention. It should be noted that the components shown in FIG. 6 and having identical or corresponding counterparts in FIG. 1 are denoted by reference signs with the last two digits common to both figures, and the descriptions of those components will be appropriately omitted.

The component capture unit 200 includes: a plurality of passages each of which is provided with one of the trap columns 270; a discharging passage 280 with no trap column 270; and a passage switcher 201 configured to selectively direct the eluate from the separation column 130 to one of the trap columns 270 and the discharging passage 280. Each trap column 270 is packed with a capturing material for trapping sample components. Although the configuration shown in FIG. 6 has six trap columns 270, the number of trap columns 270 to be provided in the component capture unit 200 may be any number equal to or greater than two and is not limited to six.

The solvent supply unit 300 includes a solvent supply pump 302 for suctioning an eluting solvent contained in a solvent container 301 as well as a switching valve 303 located on a passage between the LC unit 110 and the component capture unit 200. The switching valve 303 is used for selectively sending either the eluate from the LC unit 110 or the eluting solvent supplied by the solvent supply pump 302 to the component capture unit 200.

In this type of preparative liquid chromatograph, the sample injection by the automatic sample injection device 120 is initially performed with the passage system configured so that the eluate will be discharged into the drain via the switching valve 303, passage switcher 201, discharging passage 280 and dispensing valve 155. The passage switcher 201 is operated to select one of the trap columns 270 at the timing when the fraction corresponding to the beginning point of a peak on the chromatogram in the eluate from the separation column 130 arrives at the passage switcher 201. After that, the passage switcher 201 is operated to select the discharging passage 280 at the timing when the fraction of the eluate corresponding to the ending point of the peak arrives at the passage switcher 201. Consequently, the sample component corresponding to the peak in question is captured in the trap column 270 (this process is hereinafter called the “capturing process”). After the completion of the capturing process, a predetermined trap column 270 is selected by the passage switcher 201, and subsequently, the solvent supply pump 302 is energized and the switching valve 303 is operated to direct the eluting solvent to the predetermined trap column 270, whereby the sample component is eluted from this trap column 270 (this process is hereinafter called the “elution process”). The liquid exiting from the trap column in the elution process (the eluting solvent containing the sample component) is introduced into the fraction collector 150 and collected in one of the collection containers 151 corresponding to the trap columns 270.

In the preparative liquid chromatograph according to the present embodiment, the processing as shown by the flowchart of FIG. 3 or the processing as shown by the flowchart of FIG. 5 is performed in the capturing process. However, in the present case, it should be noted that the fraction corresponding to a peak on a chromatogram in the eluate from the separation column 130 is not collected in a collection container 151 but is introduced into one of the trap columns 270 in Steps 104 and 109 in the flowchart of FIG. 3 as well as Steps 204 and 210 or 211 in the flowchart of FIG. 5.

For example, when the processing as shown by the flowchart of FIG. 3 is performed in the capturing process, each fraction corresponding to a peak in the eluate from the separation column 130 resulting from the first sample injection is introduced into a different trap column 270 in Step 104 of the flowchart. Consequently, the sample components corresponding to the peaks are individually captured in separate trap columns 270. In the later Step 109, when the eluate is exiting from the separation column 130 after the second or subsequent sample injection, only the fraction of the eluate corresponding to a peak which has been concluded to be identical to one of the peaks which emerged from the first sample injection (“compared peaks”) is introduced into a trap column 270 (which is either the same trap column 270 as used for capturing the sample component corresponding to the compared peak which has been concluded to be identical, or a different column 270), while the fraction of the eluate corresponding to a peak which has been concluded to be identical to none of the peaks which emerged from the first sample injection is discharged into the drain via the discharging passage 280 in the component capture unit 200 and the dispensing valve 155 in the fraction collector 150.

On the other hand, when the processing as shown by the flowchart of FIG. 5 is performed in the capturing process, each fraction corresponding to a peak in the eluate exiting from the separation column 130 after the first sample injection is introduced into a different trap column 270 in Step 204 of the flowchart. In the later Step 209, when the eluate is exiting from the separation column 130 after the second or subsequent sample injection, the fraction of the eluate corresponding to a peak which has been concluded to be identical to one of the peaks which emerged from the foregoing sample injections (“compared peaks”) is introduced into the same trap column 270 as used for capturing the sample component corresponding to the compared peak which has been concluded to be identical, while the fraction which has been concluded to be identical to none of the peaks which emerged from the foregoing sample injections is introduced into a new trap column 270 (a trap column 270 which has not yet been used for the capturing processes accompanying the first through (N−1)-th sample injections, provided that the latest sample injection is the N-th injection, where N is equal to or greater than two).

After a plurality of sample injections and a plurality of capturing processes accompanying those injections have been completed in the previously described manner, the previously described elution process is performed, whereby the sample component captured in each trap column 270 is eluted and collected in the fraction collector 150. Consequently, a liquid containing a sample component eluted from each different trap column 270 is individually collected in each collection container 151 in the fraction collector 150.

Modes for carrying out the present invention have been described thus far with reference to the specific examples. The present invention is not limited to the previously described embodiments. Appropriate changes or modifications are allowed within the spirit of the present invention. For example, it is not always necessary to perform the automatic preparative separation as shown in the flowchart of FIG. 3 or 5 for all samples set in the automatic sample injection device 20 or 120 as in the previously described embodiments; the automatic preparative separation as shown in the flowchart of FIG. 3 or 5 may be selectively performed for two or more samples previously designated by the user among the samples set in the automatic sample injection device 20 or 120, while an automatic preparative separation similar to a conventional method may be performed for the other samples.

In the previously described embodiment, the sample to be injected into the injector 24 is suctioned from a different sample container 21 in each of the plurality of sample injections. Alternatively, the sample to be injected into the injector 24 may always be suctioned from the same sample container 21 in all of the plurality of sample injections.

### Modes

It is evident to a person skilled in the art that the previously described illustrative embodiments are specific examples of the following modes of the present invention.

(Clause 1) A method for controlling a preparative liquid chromatograph according to one mode of the present invention is a method for controlling a preparative liquid chromatograph having a separation column configured to separate a plurality of sample components contained in a sample injected into a passage, a detector located downstream from the separation column, a chromatogram creator configured to create a chromatogram based on a detection result by the detector, and a separative collector configured to perform a separative collection, from an eluate from the separation column, of a sample component corresponding to a peak on the chromatogram, where the method includes performing the following operations when the preparative separation of sample components accompanying a sample injection is performed for each of a plurality of sample injections into the passage:
when the preparative separation of sample components accompanying the first sample injection among the plurality of sample injections is performed, the separative collection of a sample component corresponding to a peak is performed by the separative collector for each of the peaks emerging on a first chromatogram which is a chromatogram created by the chromatogram creator in connection with the first sample injection, and the beginning time of each of the aforementioned peaks on the first chromatogram is stored; and
when the preparative separation of sample components accompanying the second or subsequent sample injection among the plurality of sample injections is performed, every peak emerging on a target chromatogram which is a chromatogram created by the chromatogram creator in connection with the second or subsequent sample injection is designated as a determination target peak, a determination of whether or not the determination target peak originates from the same component as one of the aforementioned peaks is made based on the beginning time of the determination target peak on the target chromatogram and the beginning time of each of the aforementioned peaks on the first chromatogram, and the separative collector is operated to perform a predetermined separative collection operation based on the result of the determination.

(Clause 2) In the method for controlling a preparative liquid chromatograph according to Clause 2, which is a method for controlling a preparative liquid chromatograph according to Clause 1, the predetermined separative collection operation includes performing the separative collection of the sample component corresponding to the determination target peak when it is concluded, in the determination, that the determination target peak originates from the same component as one of the aforementioned peaks on the first chromatogram, while bypassing the separative collection of the sample component corresponding to the determination target peak when it is concluded that the determination target peak does not originate from the same component as any one of the aforementioned peaks on the first chromatogram.

(Clause 3) In the method for controlling a preparative liquid chromatograph according to Clause 3, which is a method for controlling a preparative liquid chromatograph according to Clause 1, the predetermined separative collection operation includes performing the separative collection of the sample component corresponding to the determination target peak so that, when it is concluded, in the determination, that the determination target peak originates from the same component as one of the aforementioned peaks on the first chromatogram, the sample component corresponding to the determination target peak is sent to the same separative-collection destination, among a plurality of separative-collection destinations included in the separative collector, as the separative-collection destination of a sample component corresponding to the one of the aforementioned peaks which was concluded to originate from the same component as the determination target peak, and when it is concluded that the determination target peak does not originate from the same component as any one of the aforementioned peaks on the first chromatogram, the separative collection of the sample component corresponding to the determination target peak is bypassed or the sample component is sent to a separative-collection destination different from the separative-collection destinations to which the sample components corresponding to the aforementioned peaks were sent among the plurality of separative-collection destinations.

(Clause 4) A preparative liquid chromatograph according to one mode of the present invention is a preparative liquid chromatograph having a separation column configured to separate a plurality of sample components contained in a sample injected into a passage, a detector located downstream from the separation column, a chromatogram creator configured to create a chromatogram based on a detection result by the detector, a separative collector configured to perform a separative collection, from an eluate from the separation column, of a sample component corresponding to a peak on the chromatogram, and a separative collection controller configured to control the separative collector, where the separative collection controller is configured to perform the following operations when the preparative separation of sample components accompanying a sample injection is performed for each of a plurality of sample injections into the passage:
when the preparative separation of sample components accompanying the first sample injection among the plurality of sample injections is performed, the separative collection controller controls the separative collector to perform the separative collection of a sample component corresponding to a peak for each of the peaks emerging on a first chromatogram which is a chromatogram created by the chromatogram creator in connection with the first sample injection, and stores the beginning time of each of the aforementioned peaks on the first chromatogram; and
when the preparative separation of sample components accompanying the second or subsequent sample injection among the plurality of sample injections is performed, the separative collection controller designates, as a determination target peak, every peak emerging on a target chromatogram which is a chromatogram created by the chromatogram creator in connection with the second or subsequent sample injection, makes a determination of whether or not the determination target peak originates from the same component as one of the aforementioned peaks based on the beginning time of the determination target peak on the target chromatogram and the beginning time of each of the aforementioned peaks on the first chromatogram, and controls the separative collector to perform a predetermined separative collection operation based on the result of the determination.

(Clause 5) In the preparative liquid chromatograph according to Clause 5, which is a preparative liquid chromatograph according to Clause 4, the predetermined separative collection operation includes performing the separative collection of the sample component corresponding to the determination target peak when it is concluded, in the determination, that the determination target peak originates from the same component as one of the aforementioned peaks on the first chromatogram, while bypassing the separative collection of the sample component corresponding to the determination target peak when it is concluded that the determination target peak does not originate from the same component as any one of the aforementioned peaks on the first chromatogram.

(Clause 6) In the preparative liquid chromatograph according to Clause 6, which is a preparative liquid chromatograph according to Clause 4, the predetermined separative collection operation includes performing the separative collection of the sample component corresponding to the determination target peak so that, when it is concluded, in the determination, that the determination target peak originates from the same component as one of the aforementioned peaks on the first chromatogram, the sample component corresponding to the determination target peak is sent to the same separative-collection destination, among a plurality of separative-collection destinations included in the separative collector, as the separative-collection destination of a sample component corresponding to the one of the aforementioned peaks which was concluded to originate from the same component as the determination target peak, and when it is concluded that the determination target peak does not originate from the same component as any one of the aforementioned peaks on the first chromatogram, the separative collection of the sample component corresponding to the determination target peak is bypassed or the sample component is sent to a separative-collection destination different from the separative-collection destinations to which the sample components corresponding to the aforementioned peaks were sent among the plurality of separative-collection destinations.

### REFERENCE SIGNS LIST

10 . . . LC Unit
20 . . . Automatic Sample Injection Device
21 . . . Sample Container
30 . . . Separation Column
40 . . . Detector
50 . . . Fraction Collector
51 . . . Collection Container
53 . . . Dispensing Nozzle
60 . . . Control/Processing Unit
61 . . . LC Controller
62 . . . Collection Controller
63 . . . Chromatogram Creator
64 . . . Peak Detector
65 . . . Determiner
67 . . . Beginning Time Storage Section

1. A method for controlling a preparative liquid chromatograph having a separation column configured to separate a plurality of sample components contained in a sample injected into a passage, a detector located downstream from the separation column, a chromatogram creator configured to create a chromatogram based on a detection result by the detector, and a separative collector configured to perform a separative collection, from an eluate from the separation column, of a sample component corresponding to a peak on the chromatogram, wherein the method comprises performing following operations when a preparative separation of sample components accompanying a sample injection is performed for each of a plurality of sample injections into the passage:
when the preparative separation of sample components accompanying a first sample injection among the plurality of sample injections is performed, the separative collection of a sample component corresponding to a peak is performed by the separative collector for each of peaks emerging on a first chromatogram which is a chromatogram created by the chromatogram creator in connection with the first sample injection, and a beginning time of each of the aforementioned peaks on the first chromatogram is stored; and
when the preparative separation of sample components accompanying a second or subsequent sample injection among the plurality of sample injections is performed, every peak emerging on a target chromatogram which is a chromatogram created by the chromatogram creator in connection with the second or subsequent sample injection is designated as a determination target peak, a determination of whether or not the determination target peak originates from a same component as one of the aforementioned peaks is made based on the beginning time of the determination target peak on the target chromatogram and the beginning time of each of the aforementioned peaks on the first chromatogram, and the separative collector is operated to perform a predetermined separative collection operation based on a result of the determination.

2. The method for controlling a preparative liquid chromatograph according to claim 1, wherein the predetermined separative collection operation includes performing the separative collection of the sample component corresponding to the determination target peak when it is concluded, in the determination, that the determination target peak originates from the same component as one of the aforementioned peaks on the first chromatogram, while bypassing the separative collection of the sample component corresponding to the determination target peak when it is concluded that the determination target peak does not originate from the same component as any one of the aforementioned peaks on the first chromatogram.

3. The method for controlling a preparative liquid chromatograph according to claim 1, wherein the predetermined separative collection operation includes performing the separative collection of the sample component corresponding to the determination target peak so that, when it is concluded, in the determination, that the determination target peak originates from the same component as one of the aforementioned peaks on the first chromatogram, the sample component corresponding to the determination target peak is sent to a same separative-collection destination, among a plurality of separative-collection destinations included in the separative collector, as the separative-collection destination of a sample component corresponding to the one of the aforementioned peaks which was concluded to originate from the same component as the determination target peak, and when it is concluded that the determination target peak does not originate from the same component as any one of the aforementioned peaks on the first chromatogram, the separative collection of the sample component corresponding to the determination target peak is bypassed or the sample component is sent to a separative-collection destination different from the separative-collection destinations to which the sample components corresponding to the aforementioned peaks were sent among the plurality of separative-collection destinations.

4. A preparative liquid chromatograph having a separation column configured to separate a plurality of sample components contained in a sample injected into a passage, a detector located downstream from the separation column, a chromatogram creator configured to create a chromatogram based on a detection result by the detector, a separative collector configured to perform a separative collection, from an eluate from the separation column, of a sample component corresponding to a peak on the chromatogram, and a separative collection controller configured to control the separative collector, wherein the separative collection controller is configured to perform following operations when a preparative separation of sample components accompanying a sample injection is performed for each of a plurality of sample injections into the passage:
when the preparative separation of sample components accompanying a first sample injection among the plurality of sample injections is performed, the separative collection controller controls the separative collector to perform the separative collection of a sample component corresponding to a peak for each of peaks emerging on a first chromatogram which is a chromatogram created by the chromatogram creator in connection with the first sample injection, and stores a beginning time of each of the aforementioned peaks on the first chromatogram; and
when the preparative separation of sample components accompanying a second or subsequent sample injection among the plurality of sample injections is performed, the separative collection controller designates, as a determination target peak, every peak emerging on a target chromatogram which is a chromatogram created by the chromatogram creator in connection with the second or subsequent sample injection, makes a determination of whether or not the determination target peak originates from a same component as one of the aforementioned peaks based on the beginning time of the determination target peak on the target chromatogram and the beginning time of each of the aforementioned peaks on the first chromatogram, and controls the separative collector to perform a predetermined separative collection based on a result of the determination.

5. The preparative liquid chromatograph according to claim 4, wherein the predetermined separative collection operation includes performing the separative collection of the sample component corresponding to the determination target peak when it is concluded, in the determination, that the determination target peak originates from the same component as one of the aforementioned peaks on the first chromatogram, while bypassing the separative collection of the sample component corresponding to the determination target peak when it is concluded that the determination target peak does not originate from the same component as any one of the aforementioned peaks on the first chromatogram.

6. The preparative liquid chromatograph according to claim 4, wherein the predetermined separative collection operation includes performing the separative collection of the sample component corresponding to the determination target peak so that, when it is concluded, in the determination, that the determination target peak originates from the same component as one of the aforementioned peaks on the first chromatogram, the sample component corresponding to the determination target peak is sent to a same separative-collection destination, among a plurality of separative-collection destinations included in the separative collector, as the separative-collection destination of a sample component corresponding to the one of the aforementioned peaks which was concluded to originate from the same component as the determination target peak, and when it is concluded that the determination target peak does not originate from the same component as any one of the aforementioned peaks on the first chromatogram, the separative collection of the sample component corresponding to the determination target peak is bypassed or the sample component is sent to a separative-collection destination different from the separative-collection destinations to which the sample components corresponding to the aforementioned peaks were sent among the plurality of separative-collection destinations.
